(19) United States
(12) Patent Application Publication
(10) Pub. No.: US 2022/0027596 A1
(43) Pub. Date: Jan. 27, 2022

(54) IMAGE SENSING APPARATUS AND EXPOSURE TIME ADJUSTMENT METHOD THEREOF

(71) Applicant: Egis Technology Inc., Hsinchu City (TW)

(72) Inventor: Wan-Jung Lo, Hsinchu City (TW)

(73) Assignee: Egis Technology Inc., Hsinchu City (TW)

(21) Appl. No.: 17/338,700

(22) Filed: Jun. 4, 2021

Related U.S. Application Data
(60) Provisional application No. 63/055,855, filed on Jul. 23, 2020.

(51) Int. Cl. G06K 9/00; H04N 5/235; G06K 9/20

(52) U.S. Cl. CPC G06K 9/0004; G06K 9/209; H04N 5/2353

(57) ABSTRACT

An image sensing apparatus and an exposure time adjustment method thereof are provided. A light sensing unit receives a light signal including image information and generates a sensing signal. An exposure time adjustment circuit is integrated in a chip and adjusts an exposure time of the light sensing unit according to the sensing signal.

### CROSS-REFERENCE TO RELATED APPLICATION

This application claims the priority benefit of U.S. Provisional Application No. 63/055,855, filed on Jul. 23, 2020 and China Application No. 202110384150.7, filed on Apr. 9, 2021. The entirety of each of the above-mentioned patent applications is hereby incorporated by reference herein and made a part of this specification.

### BACKGROUND

### Technical Field

The invention relates to a sensing apparatus, and particularly relates to an optical image sensing apparatus and an exposure time adjustment method thereof.

### Description of Related Art

A common image sensing apparatus may include a sensing pixel array composed of a plurality of sensing pixels, each sensing pixel may convert incident light into a sensing signal, by analyzing the sensing signal provided by each of the sensing pixels, an image sensed by the sensing pixel array may be obtained. Furthermore, each sensing pixel may include a photodiode, which may convert light into an electrical signal, and continuous exposure of the photodiode may cause continuous decrease of a voltage value of the sensing signal output by the sensing pixel, and the image sensed by each sensing pixel may be obtained by reading the voltage value of the sensing signal. However, when an exposure amount is too small (for example, when an exposure time is too short), i.e., the voltage value of the sensing signal is too small, a resolution of a reading circuit is probably insufficient, and the sensing signal cannot be read correctly. Therefore, an appropriate exposure time has a great influence on the sensing quality of the image sensing apparatus.

Exposure time adjustment of a general image sensing apparatus requires transmitting the sensing signals provided by the sensing pixels in the image sensing apparatus to an external host through a system board and a serial peripheral interface, so as to use the external host to determine whether a firmware setting of the image sensing apparatus needs to be modified, and adjust the exposure time of the image sensing apparatus to an appropriate time length. According to such method, although the image sensing apparatus may have the appropriate exposure time, and may provide a clear sensing image, but it has problems of poor efficiency, increased production cost, and errors generated in a signal conversion process to cause a risk of adjustment failure of the exposure time.

### SUMMARY

The invention is directed to an exposure time adjustment method of an image sensing apparatus, which is capable of greatly improving efficiency of adjusting an exposure time of the image sensing apparatus, and effectively reducing the production cost of the image sensing apparatus and a failure rate of exposure time adjustment.

The invention provides an image sensing apparatus including at least one light sensing unit and an exposure time adjustment circuit. The light sensing unit senses a light signal including image information to generate a sensing signal. The exposure time adjustment circuit is coupled to the light sensing unit, and the exposure time adjustment circuit is integrated in a chip, and adjusts an exposure time of the light sensing unit according to the sensing signal.

The invention provides an exposure time adjustment method of an image sensing apparatus, which includes following steps. An exposure time adjustment circuit integrated in a chip is provided. The exposure time adjustment circuit receives a sensing signal generated by at least one light sensing unit by sensing a light signal including image information. The exposure time adjustment circuit adjusts an exposure time of the light sensing unit according to the sensing signal.

Based on the above description, the embodiment of the invention integrates the exposure time adjustment circuit into the chip connected to the light sensing unit, and may directly adjust the exposure time of the light sensing unit according to the sensing signal provided by the light sensing unit without using the external host to perform the exposure time adjustment, so that the efficiency of adjusting the exposure time of the image sensing apparatus is greatly improved, and the production cost of the image sensing apparatus is effectively reduced. Moreover, since the exposure time adjustment circuit may directly perform the exposure time adjustment according to the sensing signal provided by the light sensing unit without using other devices to perform pre-processing such as signal conversion on the sensing signal, occurrence of signal conversion errors is avoided, and a failure rate of exposure time adjustment is effectively reduced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an image sensing apparatus according to an embodiment of the invention.

FIG. 2 is a schematic diagram of an image sensing apparatus according to another embodiment of the invention.

FIG. 3 is a flowchart of an exposure time adjustment method of an image sensing apparatus according to an embodiment of the invention.

### DESCRIPTION OF THE EMBODIMENTS

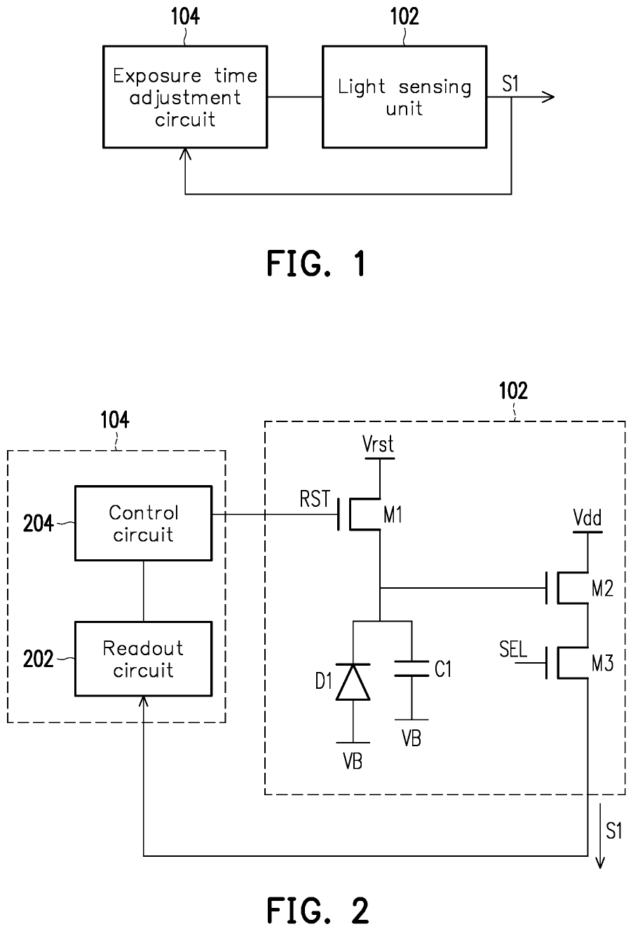

FIG. 1 is a schematic diagram of an image sensing apparatus according to an embodiment of the invention. Referring to FIG. 1, the image sensing apparatus may include a light sensing unit 102 and an exposure time adjustment circuit 104, where the light sensing unit 102 is coupled to the exposure time adjustment circuit 104. The image sensing apparatus may be, for example, a fingerprint sensor or an X-ray flat panel sensor, but the invention is not limited thereto. The light sensing unit 102 may receive a light signal including image information to generate a sensing signal S1, and the image information may include fingerprint information or palmprint information. The exposure time adjustment circuit 104 is integrated in a chip connected to the light sensing unit 102, such as a fingerprint image reading chip, a fingerprint identification algorithm chip, etc., connected to the light sensing unit 102 on a flexible circuit board, but the invention is not limited thereto.

The exposure time adjustment circuit 104 may adjust an exposure time of the light sensing unit 102 according to the sensing signal S1 provided by the light sensing unit 102. For example, the exposure time adjustment circuit 104 may adjust the exposure time of the light sensing unit 102 according to a signal-to-noise ratio of the sensing signal S1. For example, when the exposure time of the light sensing unit 102 is insufficient, the signal-to-noise ratio of the sensing signal S1 may be low, and the exposure time adjustment circuit 104 may control the light sensing unit 102 to increase an exposure time length to increase the signal-to-noise ratio of the sensing signal S1 to a predetermined range, thereby adjusting the exposure time of the light sensing unit 102 to an appropriate time length. It should be noted that the number of the light sensing units 102 included in the image sensing apparatus is not limited to the embodiment. In some embodiments, the image sensing apparatus may include a plurality of light sensing units 102, and the exposure time adjustment circuit 104 may adjust the exposure time of the plurality of light sensing units 102 based on a plurality of sensing signals of the plurality of light sensing units 102. For example, the exposure time of each light sensing unit 102 may be adjusted according to an average value of the signal-to-noise ratios of the plurality of sensing signals.

In some embodiments, the exposure time adjustment circuit 104 may also adjust the exposure time of the light sensing unit 102 according to a voltage value corresponding to the image information included in the sensing signal S1. For example, the light sensing unit 102 may generate the sensing signal S1 corresponding to a fingerprint peak and the sensing signal S1 corresponding to a fingerprint trough at different time points, and the exposure time adjustment circuit 104 may determine a voltage difference between the voltage corresponding the fingerprint peak and the voltage corresponding to the fingerprint trough according to the sensing signal S1. Since when the exposure time of the light sensing unit 102 is appropriate, the voltage difference may be greater than a predetermined voltage difference, the exposure time adjustment circuit 104 may adjust the exposure time of the light sensing unit 102 according to the voltage difference to make the voltage difference to be greater than the predetermined voltage difference, thereby adjusting the exposure time of the light sensing unit 102 to an appropriate time length. Moreover, in the embodiment where the image sensing apparatus includes a plurality of the light sensing units 102, the plurality of light sensing units 102 at different positions may respectively generate the sensing signals S1 corresponding to the fingerprint peaks or the sensing signals S1 corresponding to the fingerprint troughs, and the exposure time adjustment circuit 104 may determine a voltage difference between an average voltage corresponding to the plurality of fingerprint peaks and an average voltage corresponding to the plurality of fingerprint troughs according to the sensing signals S1 generated by the plurality of light sensing units 102, and adjust the exposure time of each of the light sensing units 102 according to the voltage difference.

In other embodiments, the exposure time adjustment circuit 104 may also adjust the exposure time of the light sensing unit 102 according to a comparison result of the sensing signal S1 and a predetermined voltage threshold. Since when the exposure time of the light sensing unit 102 is too short, the voltage value of the sensing signal S1 is too small, the exposure time adjustment circuit 104 may adjust the exposure time of the light sensing unit 102 according to whether the sensing signal S1 is greater than the predetermined voltage threshold to make the voltage value of the sensing signal S1 to be greater than the predetermined voltage threshold, thereby adjusting the exposure time of the light sensing unit 102 to the appropriate time length. It should be noted that in some embodiments, the exposure time adjustment circuit 104 may compare the sensing signal S1 with a plurality of different predetermined voltage thresholds. For example, when the voltage of the sensing signal S1 is within a different predetermined voltage threshold interval, the exposure time adjustment circuit 104 may correspondingly adjust the exposure time of the light sensing unit 102 to a corresponding time length, so as to adjust the exposure time of the light sensing unit 102 more subtly. In the embodiment where the image sensing apparatus includes a plurality of the light sensing units 102, the exposure time adjustment circuit 104 may adjust the exposure time of each of the light sensing units 102 according to a comparison result between an average voltage value of the sensing signals S1 generated by the plurality of light sensing units 102 and a predetermined voltage threshold or a plurality of predetermined voltage thresholds.

In this way, by adjusting the exposure time of the light sensing unit 102 by the exposure time adjustment circuit 104 integrated in the chip connected to the light sensing unit 102, it is unnecessary to use other external devices to perform the exposure time adjustment as that does in the prior art, so that the efficiency of adjusting the exposure time of the image sensing apparatus may be greatly improved, and the production cost of the image sensing apparatus may be effectively reduced. In addition, since the exposure time adjustment circuit 104 may directly perform the exposure time adjustment according to the sensing signal S1 provided by the light sensing unit 102 without using other external devices to perform pre-processing such as signal conversion on the sensing signal S1, errors occurred in the signal conversion process may be avoided, thereby effectively reducing the failure rate of the exposure time adjustment.

FIG. 2 is a schematic diagram of an image sensing apparatus according to another embodiment of the invention. Referring to FIG. 2, in the embodiment, the light sensing unit 102 may include a photoelectric conversion unit D1, a parasitic capacitor C1, a reset transistor M1, an amplification transistor M2, and a selection transistor M3. A first terminal of the reset transistor M1 is coupled to a reset voltage Vrst, and a control terminal of the reset transistor M1 is coupled to the exposure time adjustment circuit 104. The photoelectric conversion unit D1 may be, for example, a photodiode, but the invention is not limited thereto, and a cathode and an anode thereof are respectively coupled to a second terminal of the reset transistor M1 and a reference voltage VB (in the embodiment, the reference voltage VB is grounded, but the invention is not limited thereto), the parasitic capacitor C1 is generated between a common node of the photoelectric conversion unit D1 and the reset transistor M1 and the reference voltage VB. A first terminal and a second terminal of the amplification transistor M2 are respectively coupled to a power supply voltage Vdd and a first terminal of the selection transistor M3, a second terminal of the selection transistor M3 is coupled to the exposure time adjustment circuit 104, and a control terminal of the selection transistor M3 is coupled to a selection control signal SEL. In addition, in the embodiment, the exposure time adjustment circuit 104 may include a readout circuit 202 and a control circuit 204. The readout circuit 202 is coupled to the second terminal of the selection transistor M3 and the control circuit 204, and the control circuit 204 is coupled to the control terminal of the reset transistor M1.

The reset transistor M1 may be controlled by a reset control signal RST output by the control circuit 204 to be turned on during a reset period and turned off during an exposure period. By adjusting a conduction state of the reset transistor M1 a time length of the exposure period may be controlled. During the reset period, the reset voltage Vrst may reset a voltage of the control terminal of the amplification transistor M2 through the reset transistor M1. During the exposure period, the reset voltage Vrst is isolated by the reset transistor M1 in a turn-off state and cannot affect the voltage of the control terminal of the amplification transistor M2. At this time, a photoelectric conversion signal generated by the photoelectric conversion unit D1 through light signal conversion may cause the voltage at the control terminal of the amplification transistor M2 to drop by a voltage difference ΔV, and such voltage difference ΔV may be converted into the sensing signal S1 by the amplification transistor M2 and transmitted to the first terminal of the selection transistor M3. The selection transistor M3 may be controlled by the selection control signal SEL to transmit the sensing signal S1 to the readout circuit 202.

The readout circuit 202 may generate a readout signal to the control circuit 204 according to the sensing signal S1, and the control circuit 204 may control the exposure time of the light sensing unit according to the readout signal. Furthermore, the control circuit 204 may determine the signal-to-noise ratio of the sensing signal S1, the voltage difference between the voltage corresponding to the fingerprint peaks and the voltage corresponding to the fingerprint troughs, the voltage value of the sensing signal S1, etc., based on the readout signal, and then adjust the exposure time of the light sensing unit 102 according to the method described in the embodiment of FIG. 1, and since the adjustment method has been described in detail in the embodiment of FIG. 1, details thereof are not repeated.

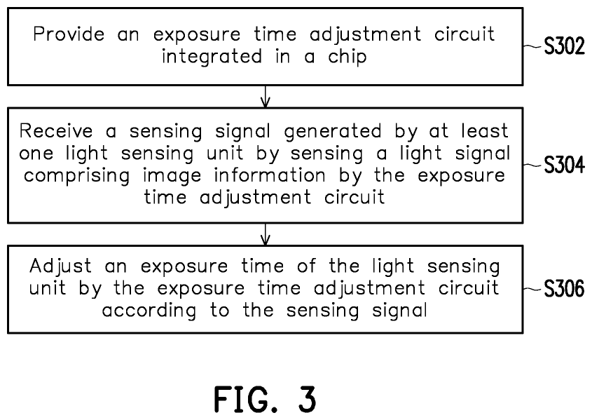

FIG. 3 is a flowchart of an exposure time adjustment method of an image sensing apparatus according to an embodiment of the invention. Referring to FIG. 3, according to the aforementioned embodiments, it is known that the exposure time adjustment method of the image sensing apparatus may at least include the following steps. First, an exposure time adjustment circuit integrated in a chip is provided (step S302), where the chip may be a fingerprint image reading chip, a fingerprint identification algorithm chip, etc., connected to a light sensing unit on a flexible circuit board, but the invention is not limited thereto. Then, the exposure time adjustment circuit receives a sensing signal generated by the light sensing unit by sensing a light signal including image information (S304), where the image information may include fingerprint information or palmprint information. Then, the exposure time adjustment circuit adjusts an exposure time of the light sensing unit according to the sensing signal (S306). For example, the exposure time adjustment circuit may adjust the exposure time of the light sensing unit according to a signal-to-noise ratio of the sensing signal, or adjust the exposure time of the light sensing unit according to a voltage difference between the voltage corresponding to the fingerprint peaks and the voltage corresponding to the fingerprint troughs, or adjust the exposure time of the light sensing unit according to a comparison result of the sensing signal and at least one predetermined voltage threshold. In the embodiment where the image sensing apparatus includes a plurality of light sensing units, the exposure time adjustment circuit may adjust the exposure time of each of the light sensing units according to the plurality of sensing signals of the plurality of light sensing units, for example, adjust the exposure time of each of the light sensing units according to an average value of the signal-to-noise ratios of the plurality of sensing signals, or determine a voltage difference between an average voltage corresponding to the plurality of fingerprint peaks and an average voltage corresponding to the plurality of fingerprint troughs according to the sensing signals S1, and adjust the exposure time of each of the light sensing units 102 according to the voltage difference, or adjust the exposure time of each of the light sensing units according to a comparison result of an average voltage value of the plurality of sensing signals and the at least one predetermined voltage threshold.

In summary, the embodiment of the invention integrates the exposure time adjustment circuit into the chip connected to the light sensing unit, and may directly adjust the exposure time of the light sensing unit according to the sensing signal provided by the light sensing unit without using the external host to perform the exposure time adjustment, so that the efficiency of adjusting the exposure time of the image sensing apparatus is greatly improved, and the production cost of the image sensing apparatus is effectively reduced. Moreover, since the exposure time adjustment circuit may directly perform the exposure time adjustment according to the sensing signal provided by the light sensing unit without using other devices to perform pre-processing such as signal conversion on the sensing signal, occurrence of signal conversion errors is avoided, and a failure rate of exposure time adjustment is effectively reduced.

What is claimed is:

1. An image sensing apparatus, comprising:
at least one light sensing unit, sensing a light signal comprising image information to generate a sensing signal; and
an exposure time adjustment circuit, coupled to the light sensing unit, and the exposure time adjustment circuit being integrated in a chip and adjusting an exposure time of the light sensing unit according to the sensing signal.

2. The image sensing apparatus as claimed in claim 1, wherein the exposure time adjustment circuit adjusts the exposure time of the light sensing unit according to a signal-to-noise ratio of the sensing signal.

3. The image sensing apparatus as claimed in claim 1, wherein the image information comprises fingerprint information or palmprint information, the exposure time adjustment circuit determines a voltage difference between a voltage corresponding to a fingerprint peak and a voltage corresponding to a fingerprint trough according to the sensing signal, and adjusts the exposure time of the light sensing unit according to the voltage difference.

4. The image sensing apparatus as claimed in claim 1, wherein the exposure time adjustment circuit adjusts the exposure time of the light sensing unit according to a comparison result of the sensing signal and at least one predetermined voltage threshold.

5. The image sensing apparatus as claimed in claim 1, wherein the light sensing unit comprises:
a reset transistor, having a first terminal coupled to a reset voltage, controlled by the exposure time adjustment circuit to be turned on during a reset period and turned off during an exposure period;
a photoelectric conversion unit, coupled between a second terminal of the reset transistor and a reference voltage, and converting the light signal into a photoelectric conversion signal;
a parasitic capacitor, generated between a common node of the photoelectric conversion unit and the reset transistor and the reference voltage, and the photoelectric conversion signal being generated on the common node of the photoelectric conversion unit and the reset transistor;
an amplification transistor, having a first terminal coupled to a power supply voltage, a control terminal coupled to the second terminal of the reset transistor, and generating the sensing signal in response to a voltage value of the photoelectric conversion signal; and
a selection transistor, coupled between a second terminal of the amplification transistor and the exposure time adjustment circuit, and controlled by a selection control signal to output the sensing signal to the exposure time adjustment circuit.

6. The image sensing apparatus as claimed in claim 1, wherein the image sensing apparatus comprises a plurality of light sensing units, and the exposure time adjustment circuit adjusts exposure time of the light sensing units according to a plurality of sensing signals of the light sensing units.

7. The image sensing apparatus as claimed in claim 6, wherein the exposure time adjustment circuit adjusts the exposure time of the light sensing units according to an average value of signal-to-noise ratios of the sensing signals.

8. The image sensing apparatus as claimed in claim 6, wherein the image information comprises fingerprint information or palmprint information, and the exposure time adjustment circuit determines a voltage difference between an average voltage corresponding to a plurality of fingerprint peaks and an average voltage corresponding to a plurality of fingerprint troughs according to the sensing signals, and adjusts the exposure time of the light sensing units according to the voltage difference.

9. The image sensing apparatus as claimed in claim 6, wherein the exposure time adjustment circuit adjusts the exposure time of the light sensing units according to a comparison result of an average voltage value of the sensing signals and at least one predetermined voltage threshold.

10. The image sensing apparatus as claimed in claim 1, wherein the exposure time adjustment circuit comprises:
a readout circuit, coupled to the light sensing unit and generating a readout signal according to the sensing signal; and
a control circuit, coupled to the light sensing unit and the readout circuit, and controlling the exposure time of the light sensing unit according to the readout signal.

11. An exposure time adjustment method of an image sensing apparatus, comprising:
providing an exposure time adjustment circuit integrated in a chip;
receiving a sensing signal generated by at least one light sensing unit by sensing a light signal comprising image information by the exposure time adjustment circuit; and
adjusting an exposure time of the light sensing unit by the exposure time adjustment circuit according to the sensing signal.

12. The exposure time adjustment method of the image sensing apparatus as claimed in claim 11, wherein the exposure time adjustment circuit adjusts the exposure time of the light sensing unit according to a signal-to-noise ratio of the sensing signal.

13. The exposure time adjustment method of the image sensing apparatus as claimed in claim 11, wherein the image information comprises fingerprint information or palmprint information, the exposure time adjustment circuit determines a voltage difference between a voltage corresponding to a fingerprint peak and a voltage corresponding to a fingerprint trough according to the sensing signal, and adjusts the exposure time of the light sensing unit according to the voltage difference.

14. The exposure time adjustment method of the image sensing apparatus as claimed in claim 11, wherein the exposure time adjustment circuit adjusts the exposure time of the light sensing unit according to a comparison result of the sensing signal and at least one predetermined voltage threshold.

15. The exposure time adjustment method of the image sensing apparatus as claimed in claim 11, wherein the image sensing apparatus comprises a plurality of light sensing units, and the exposure time adjustment circuit adjusts exposure time of the light sensing units according to a plurality of sensing signals of the light sensing units.

16. The exposure time adjustment method of the image sensing apparatus as claimed in claim 15, wherein the image information comprises fingerprint information or palmprint information, and the exposure time adjustment circuit adjusts the exposure time of the light sensing units according to an average value of signal-to-noise ratios of the sensing signals.

17. The exposure time adjustment method of the image sensing apparatus as claimed in claim 15, wherein the image information comprises fingerprint information or palmprint information, and the exposure time adjustment circuit determines a voltage difference between an average voltage corresponding to a plurality of fingerprint peaks and an average voltage corresponding to a plurality of fingerprint troughs according to the sensing signals, and adjusts the exposure time of the light sensing units according to the voltage difference.

18. The exposure time adjustment method of the image sensing apparatus as claimed in claim 15, wherein the exposure time adjustment circuit adjusts the exposure time of the light sensing units according to a comparison result of an average voltage value of the sensing signals and at least one predetermined voltage threshold.
